(19) United States
(12) Patent Application Publication
(10) Pub. No.: US 2026/0228712 A1
(43) Pub. Date: Aug. 6, 2026

(54) SYSTEM, METHOD, AND STORAGE MEDIUM

(71) Applicant: Toshiba Tec Kabushiki Kaisha, Tokyo (JP)

(72) Inventors: Naotake HIRAMATSU, Ota Tokyo (JP); Kizuku INOUE, Yokohama Kanagawa (JP); Fumihide NISHIMURA, Yokohama Kanagawa (JP)

(21) Appl. No.: 19/408,206

(22) Filed: Dec. 3, 2025

(30) Foreign Application Priority Data
Feb. 6, 2025 (JP) 2025-018656

(51) Int. Cl. G06Q 20/20

(52) U.S. Cl. CPC G06Q 20/208; G06Q 20/206

(57) ABSTRACT

A system includes a POS terminal; a monitoring device connected to the POS terminal; a management terminal connected via a network to the POS terminal and the monitoring device; and an imaging device disposed above the POS terminal, connected to the monitoring device, and configured to capture images of an imaging area including the POS terminal. The monitoring device is configured to determine whether a purchaser and an article are detected in the imaging area based on the images acquired from the imaging device, determine that a departure without payment by the purchaser has been detected when the purchaser previously detected in the imaging area ceases to be detected during a checkout process started by the purchaser at the POS terminal and the article is not detected in the imaging area, and transmit a notification signal indicating the detection of the departure without payment to the management terminal.

### CROSS-REFERENCE TO RELATED APPLICATION

This application is based upon and claims the benefit of priority from Japanese Patent Application No. 2025-018656, filed Feb. 6, 2025, the entire contents of which are incorporated herein by reference.

### FIELD

Embodiments described herein relate generally to a system, a method, and a storage medium.

### BACKGROUND

In recent years, fully self-service point of sale (POS) terminals, so-called self-service POS terminals, have been widely used in retail stores, such as supermarkets and convenience stores. Purchasers operate self-service POS terminals to perform a checkout process including the registration of items to be purchased and the payment for the registered items by themselves. This makes it possible to reduce staffing and reduce labor costs.

On the other hand, the introduction of self-service POS terminals may increase the risk of fraudulent activities, such as departure without payment. For this reason, a monitoring device has been developed. The monitoring device captures a video of an activity performed by a purchaser operating a self-service POS terminal by using a camera, analyzes the video by using artificial intelligence (AI), and issues a notification when a fraudulent activity involving departure without payment is detected.

However, such a monitoring device may erroneously detect an activity as a fraudulent activity involving departure without payment even when a purchaser temporarily leaves a self-service POS terminal during checkout to, for example, pick up a plastic bag or return to the sales floor to pick up a forgotten item.

### SUMMARY OF THE INVENTION

Embodiments of this disclosure provide a system capable of efficiently and effectively preventing or suppressing fraudulent activities involving departure without payment with a reduced risk of false positive reports.

According to an aspect of this disclosure, a system includes a point of sale (POS) terminal; a monitoring device connected to the POS terminal; a management terminal that is connected via a network to the POS terminal and the monitoring device and configured to manage the POS terminal; and an imaging device that is disposed above the POS terminal, connected to the monitoring device, and configured to capture images of an imaging area including the POS terminal. The monitoring device is configured to determine whether a purchaser and an article not initially present in the imaging area are detected in the imaging area based on the images acquired from the imaging device, determine that a departure without payment by the purchaser has been detected when the purchaser previously detected in the imaging area ceases to be detected during a checkout process started by the purchaser at the POS terminal and the article is not detected in the imaging area, the checkout process including registration of items to be purchased by the purchaser, and transmit a notification signal indicating the detection of the departure without payment to the management terminal. The monitoring device is further configured to output an operation disabling signal to the POS terminal to disable operation of the POS terminal when the purchaser previously detected in the imaging area ceases to be detected during the checkout process and the article is detected in the imaging area, and stop outputting the operation disabling signal when the purchaser is detected again in the imaging area during the checkout process.

### BRIEF DESCRIPTION OF THE DRAWINGS

FIG. 1 is a diagram illustrating a schematic configuration of a checkout system according to an embodiment.

FIG. 2 is a schematic diagram showing a positional relationship between a self-service POS terminal and a purchaser operating the self-service POS terminal.

FIG. 3 is a schematic diagram illustrating an imaging area of a camera.

FIG. 4 is a schematic diagram illustrating an example of a layout of a checkout zone.

FIG. 5 is a block diagram showing a circuit configuration of a part of a monitoring device according to the embodiment.

FIG. 6 is a block diagram illustrating a functional configuration of a processor of the monitoring device according to the embodiment.

FIG. 7 is a flowchart showing a process performed by the processor of the monitoring device in accordance with a monitoring program.

FIG. 8 is a flowchart showing a process performed by the processor of the monitoring device in accordance with the monitoring program.

FIG. 9 is a flowchart showing a process performed by the processor of the monitoring device in accordance with the monitoring program.

FIG. 10 is a diagram illustrating a schematic configuration of a checkout system according to another embodiment.

FIG. 11 is a diagram illustrating an image processing area according to another embodiment.

FIG. 12 is a diagram illustrating an image processing area according to another embodiment.

### DETAILED DESCRIPTION

Hereinafter, embodiments of this disclosure are described with reference to the drawings.

### Description of Self-Checkout System

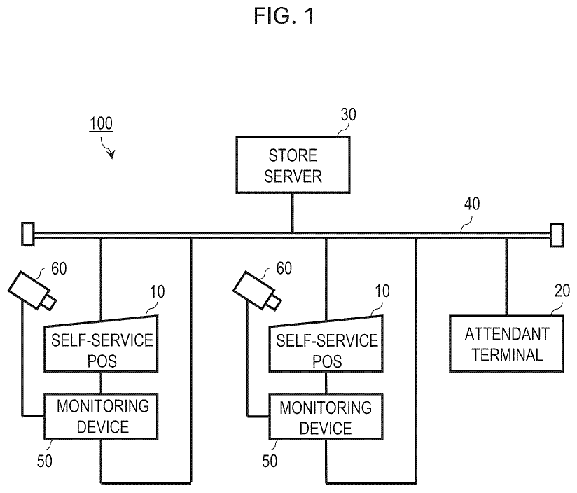

First, a checkout system 100 including a monitoring device 50 according to an embodiment will be described with reference to FIGS. 1 to 4.

FIG. 1 is a diagram schematically illustrating a configuration of the checkout system100. The checkout system100 includes a plurality of self-service POS terminals 10, an attendant terminal 20, and a store server 30. The self-service POS terminals 10, the attendant terminal 20, and the store server 30 are connected to each other via a communication network 40, such as a local area network (LAN). The store server 30 provides various services relating to the checkout system100 to the self-service POS terminals 10 and the attendant terminal 20 connected via the communication network 40.

The self-service POS terminals 10 are installed in a checkout zone RE (see FIG. 4) of a store and are operated by consumers, or purchasers, who have finished picking items. Each purchaser puts items to be purchased in a shopping basket or the like on the sales floor where items are displayed, moves to the checkout zone RE, and operates the self-service POS terminal 10 to perform a checkout process including the registration of the items and the payment of the price by themselves. The self-service POS terminal 10 is an example of a checkout device.

The attendant terminal 20 is installed in a monitoring section provided in the vicinity of the exit of the checkout zone RE. The attendant terminal 20 displays a list of items registered at each self-service POS terminal 10 on a display device. Also, when errors occur at the self-service POS terminals 10, the attendant terminal 20 reports the errors. A store clerk or an attendant, who is present in the monitoring section, monitors the checkout zone RE based on information displayed or reported by the attendant terminal 20. Although one attendant terminal 20 is illustrated in FIG. 1, a plurality of attendant terminals 20 may be connected to the communication network 40. The attendant terminal 20 is an example of a management terminal that manages the self-service POS terminals 10.

A monitoring device 50 is provided for each self-service POS terminal 10. The monitoring device 50 may be located outside or inside the self-service POS terminal 10. The monitoring device 50 is a device for monitoring a purchaser operating the self-service POS terminal 10. Specifically, the monitoring device 50 monitors a purchaser, who is operating the self-service POS terminal 10 to perform a checkout process, based on, for example, images captured by a camera 60 provided in the vicinity of the self-service POS terminal 10. The camera 60 is an example of an imaging device. The monitoring device 50 generates an alert when detecting a fraudulent activity of the purchaser. A fraudulent activity is, for example, a departure without payment, in which the customer leaves the self-service POS terminal 10 without paying the price of items to be purchased. The alert is transmitted to the attendant terminal 20. Each monitoring device 50 is connected to the attendant terminal 20 via the communication network 40 and outputs an alert signal to the attendant terminal 20. Each monitoring device 50 may output an alert signal to the attendant terminal 20 without using the communication network 40. The destination of the alert is not limited to the attendant terminal 20. The alert may also be transmitted to the self-service POS terminal 10. Furthermore, another device, such as a communication terminal (e.g., a smartphone) carried by a store clerk may be set as a destination of the alert.

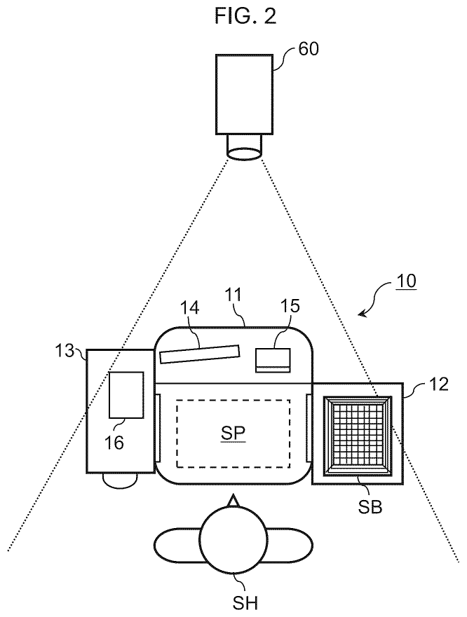

FIG. 2 is a schematic diagram showing the positional relationship between the self-service POS terminal 10 and a purchaser SH operating the self-service POS terminal 10. FIG. 2 shows the self-service POS terminal 10 from above. As shown in FIG. 2, the self-service POS terminal 10 includes a terminal housing 11, a stand 12 for placing a shopping basket SB is disposed on one side of the terminal housing 11, and an automatic change machine 13 is disposed on the other side of the terminal housing 11. Operable devices, such as a touch panel 14 and a scanner 15, are provided on the terminal housing 11, and a receipt printer 16 is provided on the automatic change machine 13. A space SP for bagging is formed on the upper side of the terminal case 11 in front of the touch panel 14 and the scanner 15.

The purchaser SH moved to the checkout zone RE stands in front of the terminal housing 11 such that the stand 12 is located on the right hand side and the automatic change machine 13 is located on the left hand side. The purchaser SH places a reusable bag or a plastic bag in the space SP, selects the reusable bag or the plastic bag by operating the touch panel 14, and then registers data of items to be purchased in the self-service POS terminal 10. That is, the purchaser SH takes out the items one by one from the shopping basket SB placed on the stand 12, and scans the barcode of each item with the scanner 15. When no barcode is attached to an item, the purchaser SH operates the touch panel 14 to display a list of items without barcodes and selects the item from the list. After registering the data of the item in the self-service POS terminal 10, the purchaser SH puts the item into the reusable bag or the plastic bag. When the data of all items to be purchased is registered, the purchaser SH operates the touch panel 14 to select a payment method. When selecting cash payment, the purchaser SH deposits cash into the automatic change machine 13. When the payment of the price is completed, a receipt is issued from the receipt printer 16. Then, the purchaser SH receives the receipt and leaves the checkout zone RE with the reusable bag or the plastic bag containing the purchased items.

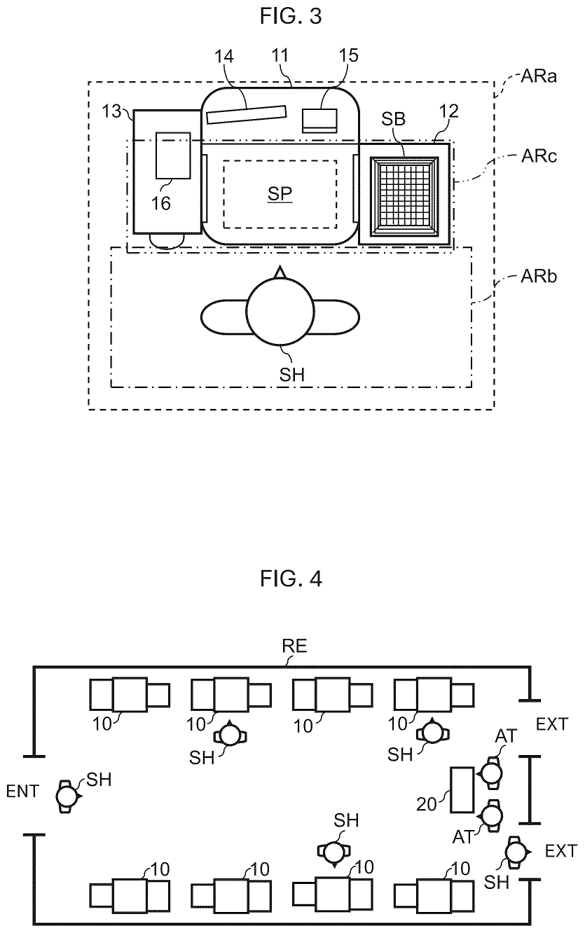

To monitor the checkout activities of the purchaser SH, the camera 60 is provided above the self-service POS terminal 10. FIG. 3 is a schematic diagram illustrating an imaging area ARa of the camera 60. As shown in FIG. 3, the imaging area ARa of the camera 60 covers the terminal housing 11, the stand 12, and the automatic change machine 13 of the self-service POS terminal 10 and a space in front of the terminal housing 11, the stand 12, and the automatic change machine 13 that the purchaser SH enters and exits. The monitoring device 50 acquires an image of the imaging area ARa from the camera 60 and sets a person detection area ARb within the imaging area ARa. The person detection area ARb is in front of the terminal housing 11 and corresponds to the operation position of the purchaser SH. The monitoring device 50 also sets an article detection area ARc including the terminal housing 11 on which a reusable bag, a plastic bag, or the like may be placed by the purchaser SH, the stand 12 on which the shopping basket SB or the like may be placed by the purchaser SH, and the automatic change machine 13 on which a personal item or the like of the purchaser SH may be placed. The person detection area ARb and the article detection area ARc may partially overlap each other.

FIG. 4 is a schematic diagram illustrating an example of a layout of the checkout zone RE. In the present embodiment, the checkout zone RE has a rectangular shape, an entrance ENT is formed on a lateral side of the checkout zone RE, and an exit EXT is formed on another lateral side of the rectangle. Two rows of self-service POS terminals 10 (in FIG. 4, four terminals in each row) are arranged along the longitudinal sides of the checkout zone RE between the entrance ENT and the exit EXT so as to face each other. The monitoring section is provided near the exit EXT, and the attendant terminal 20 is installed in the monitoring section to enable an attendant AT to monitor the checkout zone RE.

With the above described layout of the checkout zone RE, the purchaser SH who has finished picking items on the sales floor enters the checkout zone RE from the entrance ENT and stands in front of one of the self-service POS terminals 10 which is vacant. The purchaser SH then operates the self-service POS terminal 10 by themselves to register the items and pay the price of the registered items, and then exits from the exit EXT.

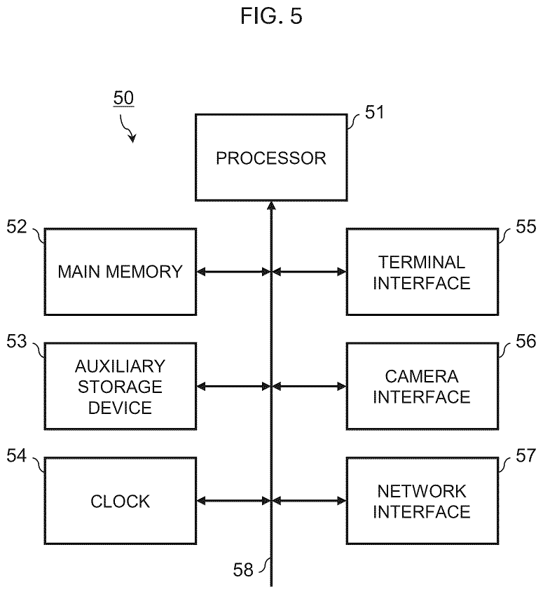

In the checkout area RE, there is a possibility of a fraudulent activity in which the purchaser SH leaves from the exit EXT without paying the price, that is, so-called departure without payment. As described above, the monitoring device 50 detects departure without payment. Specifically, the monitoring device 50 determines that a departure without payment is detected when the purchaser SH leaves the person detection area ARb before the payment is completed at the self-service POS terminal 10 at which the registration of items is started by the purchaser SH. However, the purchaser SH may leave the self-service POS terminal 10 in the middle of the checkout process for a legitimate reason. For example, the user may go to pick up a plastic bag placed near the entrance ENT or may return to the sales floor from the entrance ENT to pick up a forgotten item. The monitoring device 50 does not generate an alert for such a legitimate action. Hereinafter, the monitoring device 50 of the present embodiment that operates in this manner will be described with reference to FIGS. 5 to 9.

### Circuit Configuration of Monitoring Device

FIG. 5 is a block diagram showing a circuit configuration of the monitoring device 50. The monitoring device 50 includes circuit components, such as a processor 51, a main memory 52, an auxiliary storage device 53, a clock 54, a terminal interface 55, a camera interface 56, a network interface 57, and a system transmission line 58. The system transmission line 58 includes an address bus, a data bus, a control signal line, and the like. The monitoring device 50 is implemented as a computer in which the circuit components are connected to each other via the system transmission line 58.

The processor 51 corresponds to a central unit of the computer. The processor 51 controls other components according to an operating system or an application program (application software) to implement various functions of the monitoring device 50. The processor 51 is, for example, a central processing unit (CPU).

The main memory 52 corresponds to a main storage unit of the computer. The main memory 52 includes a nonvolatile memory area and a volatile memory area. The main memory 52 stores an operating system or an application program in the nonvolatile memory area. The main memory 52 may store data necessary for the processor 51 to perform processing for controlling other components in the nonvolatile or volatile memory area. The main memory 52 uses the volatile memory area as a work area for storing data that is rewritten by the processor 51 as necessary. The nonvolatile memory area is, for example, a read-only memory (ROM). The volatile memory area is, for example, a random access memory (RAM).

The auxiliary storage device 53 corresponds to an auxiliary storage unit of the computer. For example, an EEPROM (registered trademark) (Electric Erasable Programmable Read-Only Memory), an HDD (Hard Disc Drive), an SSD (Solid State Drive), or the like may be used for the auxiliary storage device 53. The auxiliary storage device 53 stores data used by the processor 51 to perform various processes, data generated by the processes performed by the processor 51, or the like. The auxiliary storage device 53 may also store application programs.

The clock 54 maintains the date and time. The monitoring device 50 uses the date and time maintained by the clock 54 as the current date and time.

The terminal interface 55 connects the monitoring device 50 to the self-service POS terminal 10. The terminal interface 55 controls bidirectional data communication between the monitoring device 50 and the self-service POS terminal 10. The connection between the monitoring device 50 and the self-service POS terminal 10 may be wired or wireless.

The camera interface 56 connects the monitoring device 50 to the camera 60 provided near the self-service POS terminal 10. The camera interface 56 outputs, to the camera 60, a control signal for controlling the camera 60. The camera 60 captures images of the imaging area ARa in accordance with the control signal. The camera interface 56 then acquires the images of the imaging area ARa captured by the camera 60.

The network interface 57 is connected to the communication network 40. The network interface 57 performs data communication with, for example, the attendant terminal 20 via the communication network 40. The network interface 57 can also perform data communication with other devices connected to the communication network 40.

### Functional Configuration of Monitoring Device

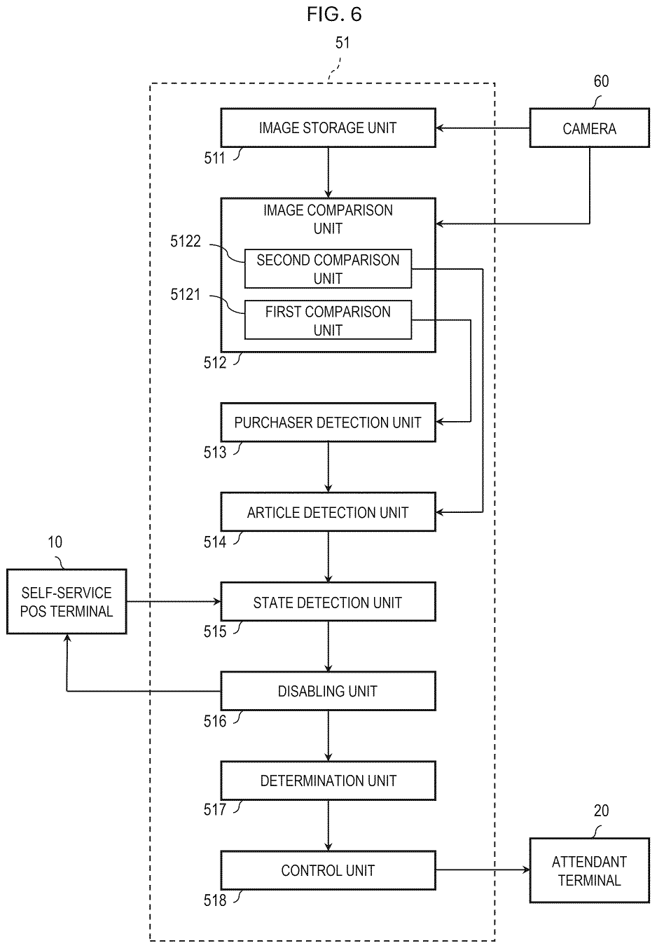

FIG. 6 is a block diagram illustrating a functional configuration of the processor 51 of the monitoring device 50. As shown in FIG. 5, the processor 51 implements an image storage unit 511, an image comparison unit 512, a purchaser detection unit 513, an article detection unit 514, a state detection unit 515, a disabling unit 516, a determination unit 517, and a control unit 518.

The image storage unit 511 stores an image of the imaging area ARa that is captured by the camera 60 from above in a state in which the purchaser SH is not present at the operation position of the self-service POS terminal 10 with which a checkout process is performed by the purchaser SH. The checkout process includes the registration of items to be purchased and the payment of the price of the items. For example, the self-service POS terminal 10 in a default state (or standby state) determines that a checkout process has been started when detecting, for example, a selection of a reusable bag or a plastic bag by the purchaser SH, a selection of a “start checkout” button, the registration of information on a first item, or the acquisition of information related to a membership card. The operation position is included in the person detection area ARb described above. Thus, the image storage unit 511 stores the image of the imaging area ARa that is captured by the camera 60 from above in a state in which the purchaser SH is not present in the person detection area ARb. Hereinafter, the image stored by the image storage unit 511 is referred to as an initial image. The initial image may be stored in the main memory 52 or the auxiliary storage device 53.

The image comparison unit 512 compares an image (or captured image) captured by the camera 60 after the checkout process is started by the purchaser SH at the self-service POS terminal 10 with the initial image stored by the image storage unit 511. The image comparison unit 512 includes a first comparison unit 5121 for comparing the person detection area Arb, which includes the operation position of the self-service POS terminal 10, across the captured image and the initial image, and a second comparison unit 5122 for comparing the article detection area Arc, which includes positions on the self-service POS terminal 10 at which the shopping basket SB, a reusable bag, and the like are placed, across the captured image and the initial image. That is, the first comparison unit 5121 compares the person detection area Arb across the captured image and the initial image, and the second comparison unit 5122 compares the article detection area Arc across the captured image and the initial image.

The purchaser detection unit 513 detects the purchaser SH at the operation position of the self-service POS terminal 10 at which a checkout process is performed. The purchaser detection unit 513 detects the purchaser SH based on the image comparison result of the first comparison unit 5121. The purchaser SH is not included in the initial image compared by the first comparison unit 5121. However, when the purchaser SH enters the person detection area ARb, the purchaser SH is included in the captured image. When detecting a captured image including the purchaser SH in the person detection area ARb based on a result of comparison between the initial image and the captured image by the first comparison unit 5121, the purchaser detection unit 203 determines that the purchaser SH has been detected. On the other hand, when detecting a captured image not including the purchaser SH in the person detection area ARb, that is, when the person detection area Arb is the same across the captured image and the initial image, the purchaser detection unit 513 determines that the purchaser SH is no longer detected.

The article detection unit 514 detects an article placed on the self-service POS terminal 10 by the purchaser SH. The article is, for example, a reusable bag or a plastic bag placed in the space SP for bagging on the terminal housing 11, the shopping basket SB placed on the stand 12, a personal item placed on the automatic change machine 13, or the like. The article detection unit 514 detects an article based on the image comparison result of the second comparison unit 5122. The initial image compared by the second comparison unit 5122 does not include any article as described above. However, when the purchaser SH places a reusable bag or a plastic bag in the space SP for bagging, places the shopping basket SB on the stand 12, or places a personal item on the automatic change machine 13, an article is included the captured image. When the article detection unit 514 detects a captured image including an article in the article detection area ARc based on a result of comparison between the initial image and the captured image by the second comparison unit 5122, the article detection unit 203 determines that an article has been detected. On the other hand, when no article is included in the article detection area ARc in the captured image, that is, when the captured image is the same as the initial image, the article detection unit 514 determines that no article has been detected. Thus, an article in the present embodiment indicates any object that is not initially present in the imaging area Ara.

The state detection unit 515 detects states of the self-service POS terminal 10. The states of the self-service POS terminal 10 includes a default state before the start of a checkout process, a registration-in-progress state after the start of item registration is instructed, a payment-in-progress state after the start of payment is instructed, and the like. The self-service POS terminal 10 transitions from the default state, to the registration-in-progress state, and to the payment-in-progress state, and then returns to the default state. The self-service POS terminal 10 outputs a state signal indicating the current state to the attendant terminal 20. The monitoring device 50 receives the state signal. The monitoring device 50 may receive the state signal via the attendant terminal 20 or may directly receive the state signal from the self-service POS terminal 10. The state detection unit 515 detects the state of the self-service POS terminal 10 based on the state signal.

The states of the self-service POS terminal 10 that can be detected based on the state signal also include a store-clerk-calling state in which a store clerk is being called. When a store clerk call button displayed on the screen of the touch panel 14 is touched during the registration-in-progress state or the payment-in-progress state, the self-service POS terminal 10 transitions to the store-clerk-calling state. The state detection unit 515 can also detect the store-clerk-calling state. The store-clerk-calling state is cancelled by a predetermined operation performed on the self-service POS terminal 10 by, for example, a store clerk, such as an attendant.

The disabling unit 516 disables the operation of the self-service POS terminal 10 upon detection of a first event and a second event until the purchaser detection unit 513 detects the purchaser SH again. The first event is an event in which the purchaser SH ceases to be detected in the person detection area ARb during the checkout process started by the purchaser SH at the self-service POS terminal 10. The second event is an event in which an article, such as a reusable bag, a plastic bag, a shopping basket, or a personal item, is placed in the article detection area ARc. That is, the disabling unit 516 outputs an operation disabling signal to the self-service POS terminal 10 when the purchaser SH previously detected by the purchaser detection unit 513 ceases to be detected but an article is detected by the article detection unit 514 while the state of the self-service POS terminal 10 detected by the state detection unit 515 is the registration-in-progress state or the payment-in-progress state,. Thereafter, when the purchaser SH is detected again by the purchaser detection unit 513, the disabling unit 516 stops outputting the operation disabling signal. In the self-service POS terminal 10, the operation of operable devices, such as the touch panel 14 and the scanner 15, are disabled while the operation disabling signal is received.

The determination unit 517 determines whether the article detected by the article detection unit 514 is not eligible to serve as counter-evidence for departure without payment. There are cases in which articles determined to be unnecessary by the purchaser SH are left, for example, in the space SP for bagging on the self-service POS terminal 10, on the stand 12, or on the upper surface of the automatic change machine 13. For example, the purchaser SH may once pick up a piece of flatware, such as a knife, a fork, a spoon, or chopsticks provided around the self-service POS terminal 10, then determine that it is not necessary, and place it on the automatic change machine 13. As another example, the purchaser SH may leave a receipt issued from the receipt printer 16. In the present embodiment, such a left article is referred to as an ineligible article that is not eligible to serve as counter-evidence for departure without payment. The determination unit 517 determines whether the article detected by the article detection unit 514 is an ineligible article. For example, the determination unit 517 stores images obtained by capturing ineligible articles in advance and calculates the degree of similarity between the image of the article detected by the article detection unit 514 and each of the stored images. Then, when the degree of similarity between the image of the article detected by the article detection unit 514 and any of the stored images is greater than or equal to a predetermined threshold value, the determination unit 517 determines that the article detected by the article detection unit 514 is an ineligible article.

The control unit 518 performs control so that a departure without payment is notified to the attendant terminal 20 when the first event described above and a third event described below occur. The third event is an event in which no article is present in the article detection area ARc. That is, the control unit 518 outputs a notification signal indicating the detection of a departure without payment when the purchaser SH previously detected by the purchaser detection unit 513 ceases to be detected and no article is detected by the article detection unit 514 while the state of the self-service POS terminal 10 detected by the state detection unit 515 is the registration-in-progress state or the payment-in-progress state. Furthermore, even if an article is detected by the article detection unit 514, the control unit 518 outputs a notification signal indicating the detection of a departure without payment when the detected article is determined to be an ineligible article by the determination unit 517. The notification signal is output to, for example, the attendant terminal 20. When the attendant terminal 20 receives the notification signal, the attendant terminal 20 notifies the user of the detection of the departure without payment. For example, the attendant terminal 20 displays an image for notifying the user of the detection of the departure without payment on a monitor. Alternatively, the attendant terminal 20 may output an alarm sound for notifying the detection of the departure without payment from a speaker. The notification signal may also be transmitted to other devices, such as the self-service POS terminal 10 and a communication terminal carried by the store clerk.

### Description of Information Processing Performed by Monitoring Device

The image storage unit 511, the image comparison unit 512, the purchaser detection unit 513, the article detection unit 514, the state detection unit 515, the disabling unit 516, the determination unit 517, and the control unit 518 of the monitoring device 50 are functions implemented by the processor 51 by performing information processing according to a monitoring program.

The monitoring program is a type of application program stored in the main memory 52 or the auxiliary storage device 53. The monitoring program may be installed in the main memory 52 or the auxiliary storage device 53 by any appropriate method. For example, the monitoring program may be provided on a removable storage medium, or distributed by communication via a network, and installed in the main memory 52 or the auxiliary storage device 53. Any non-transitory computer-readable storage medium, such as a CD-ROM, a memory card, or the like, may be used as the removable storage medium.

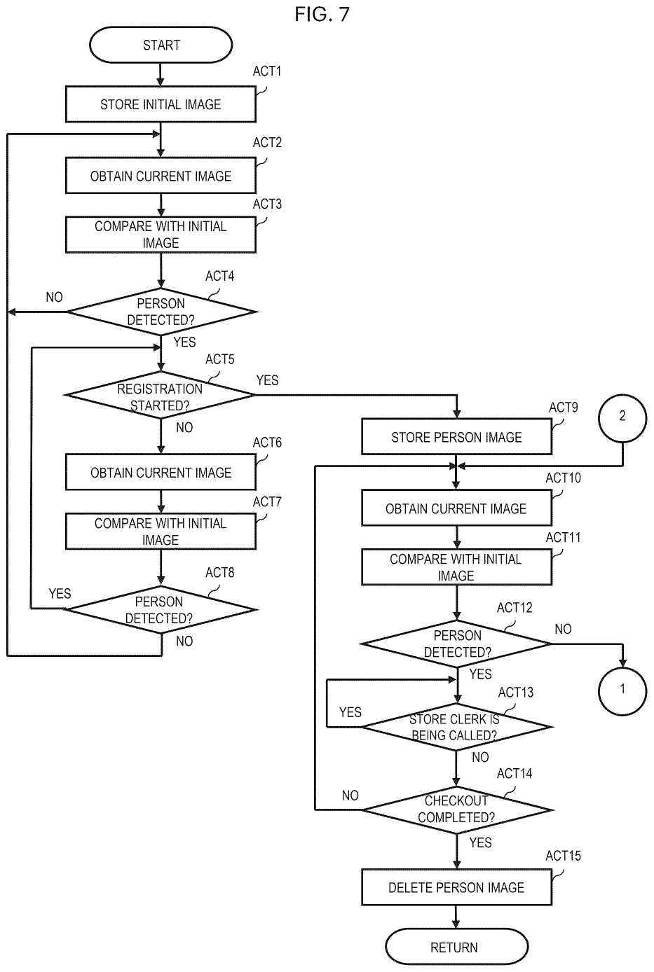

Next, an example of information processing (or process) performed by the processor 51 of the monitoring device 50 according to the monitoring program will be described with reference to the flowcharts of FIGS. 7 to 9. The processor 51 of the monitoring device 50 is configured to execute a program (or the monitoring program) stored in a memory (the main memory 52 or the auxiliary storage device 53) to perform the steps (or ACTs) in the process described below.

The processor 51 of the monitoring device 50 in the default state stores an initial image in a first image memory at ACT1. As described above, the initial image is obtained by capturing the self-service POS terminal 10 (or the imaging area ARa) from above by the camera 60 while the purchaser SH is not present in the operation position (or the imaging area ARa). The first image memory is a part of the volatile memory area in the main memory 52. The initial image is stored in advance in the auxiliary storage device 53 and is then stored in the first image memory at ACT1. Alternatively, the initial image may be obtained from the camera 60 and stored in the first image memory when the monitoring device 50 enters the default state.

After storing the initial image, the processor 51 proceeds to ACT2. The processor 51 acquires a first current image currently captured by the camera 60 at ACT2. Then, the processor 51 compares the first current image with the initial image at ACT3. That is, the processor 51 compares the initial image including no person in the person detection area ARb with the first current image. Then, the processor 51 determines whether a person is detected in the person detection area ARb in the first current image at ACT4. When no person is detected in the first current image, that is, when there is no difference in the person detection area ARb between the initial image and the first current image, the processor 51 returns to ACT2. In this case, the processor 51 repeats ACT2 through ACT4.

When a person is detected in the first current image at ACT4, the processor 51 proceeds to ACT5. At ACT5, the processor 51 determines whether registration of items to be purchased by the detected person (or purchaser SH) has been started at the self-service POS terminal 10. That is, the processor 51 determines whether the self-service POS terminal 10 has transitioned from the default state to the registration-in-progress state.

When the self-service POS terminal 10 is in the default state, the processor 51 proceeds to ACT6. The processor 51 acquires a second current image at ACT6. Then, the processor 51 compares the second current image with the initial image at ACT7. Based on the comparison result, at ACT8, the processor 51 determines whether a person is detected in the person detection area ARb in the second current image. When a person is detected in the second current image, the processor 51 returns to ACT5. Then, the processor 51 repeats ACT5 and the subsequent process.

On the other hand, when no person is detected in the second current image at ACT8, that is, when there is no difference in the person detection area ARb between the initial image and the second current image, the processor 51 returns to ACT2. The processor 51 repeats ACT2 and the subsequent process.

In this way, the processor 51 repeats ACT2 to ACT4 while no person is present in the person detection area ARb of the self-service POS terminal 10. When a person enters the person detection area ARb, the processor 51 repeats ACT5 to ACT8 until the self-service POS terminal 10 transitions to the registration-in-progress state. When the person leaves the person detection area ARb without starting the registration of items at the self-service POS terminal 10, the processor 51 repeats ACT2 to ACT4.

On the other hand, when the person who enters the person detection area ARb is the purchaser SH and performs a selection operation for selecting a reusable bag or a plastic bag at the self-service POS terminal 10 in the default state or selects a “start checkout” button displayed on the screen, the self-service POS terminal 10 transitions to the registration-in-progress state. In response to this transition, the processor 51 of the monitoring device 50 determines that the registration of items has been started at the self-service POS terminal 10. In this case, the processor 51 proceeds from ACT5 to ACT9. At ACT9, the processor 51 stores a person image in a second image memory. The person image is an image captured by the camera 60 immediately after the self-service POS terminal 10 transitions from the default state to the registration-in-progress state. The person image includes a person (or purchaser SH) present in the person detection area ARb. The second image memory is a part of the volatile memory area in the main memory 52.

After storing the person image, the processor 51 proceeds to ACT10. The processor 51 acquires a third current image at ACT10. Then, the processor 51 compares the third current image with the initial image at ACT11. Based on the comparison result, at ACT12, the processor 51 determines whether a person is detected in the person detection area ARb in the third current image. When a person is detected in the third current image, the processor 51 proceeds to ACT13. At ACT13, the processor 51 determines whether the self-service POS terminal 10 has transitioned to the store-clerk-calling state. When the self-service POS terminal 10 has transitioned to the store-clerk-calling state, the processor 51 waits until the store-clerk-calling state is cleared.

When the self-service POS terminal 10 has not transitioned to the store-clerk-calling state or when the store-clerk-calling state is cleared, the processor 51 proceeds to ACT14. At ACT14, the processor 51 determines whether the checkout process has been completed at the self-service POS terminal 10. That is, the processor 51 determines whether the self-service POS terminal 10 has transitioned from a checkout-in-progress state to the default state. When the self-service POS terminal 10 is in the registration-in-progress state or the payment-in-progress state, that is, when the checkout process has not been completed at the self-service POS terminal 10, the processor 51 returns to ACT10 and repeats ACT10 and the subsequent process.

In this way, after storing the person image, the processor 51 of the monitoring device 50 waits for the completion of the checkout process at the self-service POS terminal 10 while the person is detected in the person detection area ARb in repeatedly captured current images (for descriptive purposes, each of these images is also referred to as the third current image). When the self-service POS terminal 10 transitions to the store-clerk-calling state during the above process, the processor 51 waits until the store-clerk-calling state is cleared.

When the self-service POS terminal 10 has transitioned to the default state at ACT14, the processor 51 proceeds to ACT15. At ACT15, the processor 51 deletes the person image stored in the second image memory. Thereafter, the processor 51 returns to ACT1.

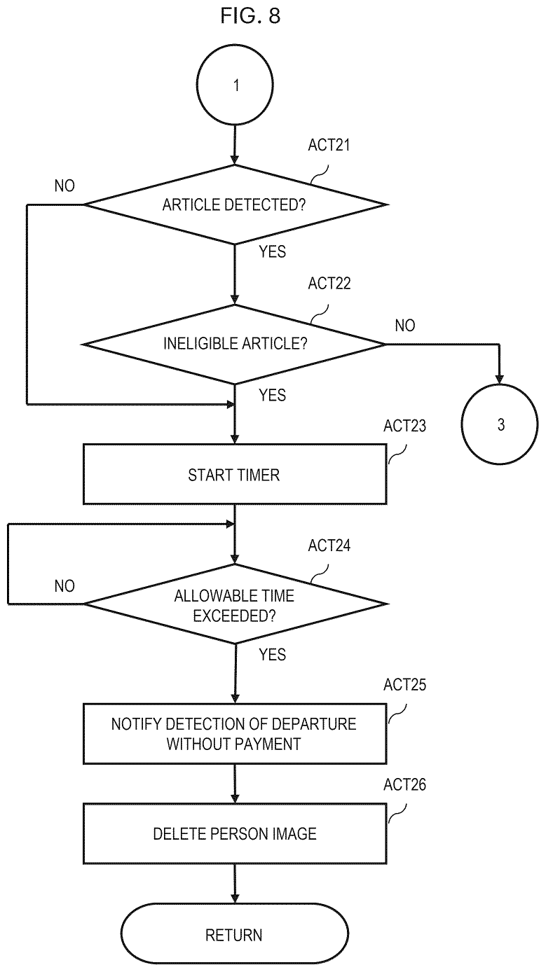

On the other hand, when no person is detected in the third current image (or any subsequent current image) at ACT12, that is, when there is no difference in the person detection area ARb between the initial image and the third current image, the processor 51 proceeds to ACT21 in FIG. 8. At ACT21, the processor 51 determines whether an article is detected in the article detection area ARc in the third current image. When no article is detected, that is, when there is no difference in the article detection area ARc between the initial image and the third current image, the processor 51 proceeds to ACT23.

On the other hand, when an article is detected in the third current image, the processor 51 proceeds to ACT22. At ACT22, the processor 51 determines whether the article is an ineligible article that is not eligible to serve as counter-evidence for departure without payment. For example, the processor 51 calculates the degree of similarity between the article in the current image and each of ineligible articles in the images stored in advance and determines whether the calculated degree of similarity is greater than or equal to a predetermined threshold value. When the degree of similarity is greater than or equal to the threshold value, the processor 51 determines that the article in the third current image is an ineligible article. Then, the processor 51 proceeds to ACT23.

In this way, when no person is detected in the person detection area ARb i the third current image and either no article is detected in the article detection area ARc in the third current image or a detected article is an ineligible article, the processor 51 proceeds to ACT23. The processor 51 starts a timer at ACT23. When the time measured by the timer exceeds an allowable time, the detection of departure without payment is notified. The allowable time is a few seconds, for example, five seconds.

At ACT24, the processor 51 determines whether the time measured by the timer has exceeded the allowable time. When the time measured by the timer has exceeded the allowable time, the processor 51 proceeds to ACT25. At ACT25, the processor 51 outputs a notification signal indicating the detection of a departure without payment. The notification signal is output to the attendant terminal 20. The notification signal may also be output to the self-service POS terminal 10, a communication terminal, such as a smartphone carried by the store clerk, or the like. Upon receipt of the notification signal, the attendant terminal 20 notifies the attendant AT of the detection of the departure without payment.

After outputting the notification signal indicating the detection of the departure without payment, the processor 51 proceeds to ACT26. At ACT26, the processor 51 deletes the person image stored in the second image memory. Thereafter, the processor 51 returns to ACT1.

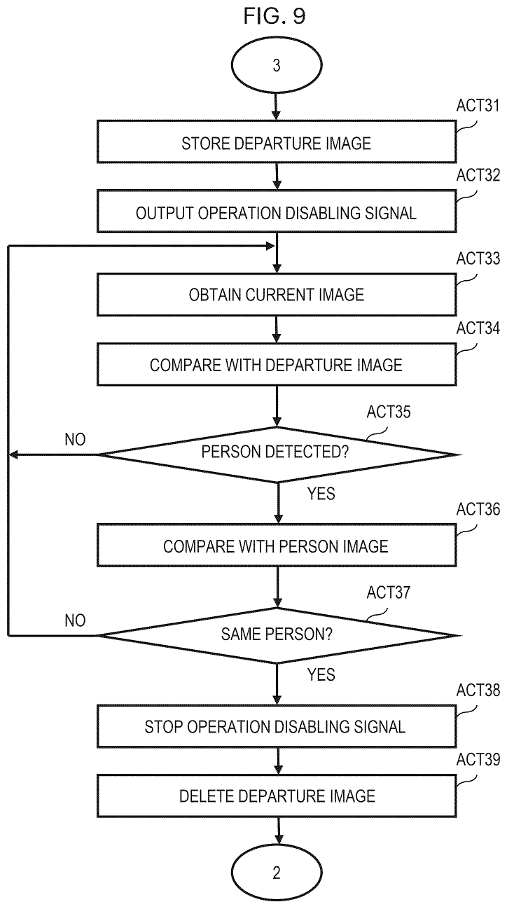

On the other hand, when it is determined at ACT22 that the article detected in the third current image is not an ineligible article, the processor 51 proceeds to ACT31 in FIG. 9. At ACT31, the processor 51 stores a departure image in a third image memory. The departure image is an image that is captured when the purchaser SH, who was detected in the person detection area ARb at ACT12, ceases to be detected. In the departure image, no person is included in the person detection area ARb. However, an article, such as a shopping basket, a reusable bag, a plastic bag, or a personal item of the purchaser SH, is present in the article detection area ARc. The third image memory is a part of the volatile memory area in the main memory 52.

After storing the departure image, the processor 51 proceeds to ACT32. At ACT32, the processor 51 outputs an operation disabling signal to the self-service POS terminal 10 in ACT32. The operation disabling signal causes the operable devices of the self-service POS terminal 10 to enter an operation disabled state.

After outputting the operation disabling signal, the processor 51 proceeds to ACT33. At ACT 33, the processor 51 acquires a fourth current image. Then, at ACT34, the processor 51 compares the fourth current image with the departure image. Based on the comparison result, at ACT35, the processor 51 determines whether a person is detected in the person detection area ARb in the fourth current image. When no person is detected in the fourth current image, that is, when there is no difference in the person detection area ARb between the departure image and the fourth current image, the processor 51 returns to ACT33. In this case, the processor 51 repeats ACT32 through ACT35. That is, the processor 51 repeats ACT33 to ACT35 until a person is detected in repeatedly captured current images (for descriptive purposes, each of these images is also referred to as the fourth current image).

When a person is detected in the fourth current image at ACT35, the processor 51 proceeds to ACT36. At ACT36, the processor 51 compares the fourth current image with the person image stored at ACT9. Then, at ACT37, the processor 51 determines whether the person in the fourth current image is the same as the person in the person image. For example, the processor 51 calculates the degree of similarity between the face image of the person in the fourth current image and the face image of the person in the person image. Then, when the degree of similarity is greater than or equal to a predetermined threshold value, the processor 51 determines that the persons in the fourth current image and the person image are the same. The processor 51 may determine whether the persons in the fourth current image and the person image are the same based also on the degrees of similarity of images of clothes, footwear, and the like.

When it is determined that the persons in the fourth current image and the person image are not the same at ACT37, the processor 51 returns to ACT33. Then, the processor 51 repeats ACT33 and the subsequent process. In this way, when a person is detected in the fourth current image but the person is different from the person in the person image, the processor 51 repeats ACT33 and the subsequent process.

On the other hand, when it is determined that the person in the fourth current image is the same as the person in the person image, the processor 51 proceeds to ACT38. At ACT38, the processor 51 stops the output of the operation disabling signal. Then, at ACT39, the processor 51 deletes the departure image stored in the third image memory. Thereafter, the processor 51 proceeds to ACT10 in FIG. 7. The processor 51 repeats ACT10 and the subsequent process.

Here, the processor 51 implements the function of the image storage unit 511 by performing ACT1. The processor 51 implements the function of the image comparison unit 512 by performing ACT2, ACT3, ACT6, ACT7, ACT10, and ACT11. The processor 51 implements the function of the purchaser detection unit 513 by performing ACT4, ACT8, and ACT12. The processor 51 implements the function of the article detection unit 514 by performing ACT21. The processor 51 implements the function of the state detection unit 515 by performing ACT5, ACT13, and ACT14. The processor 51 implements the function of the disabling unit 516 by performing ACT31 and ACT38. The processor 51 implements the function of the determination unit 517 by performing ACT22. The processor 51 implements the function of the control unit 518 by performing ACT21 to ACT26.

### Effects of Monitoring Device

As is clear from the above descriptions, when the purchaser SH leaves the self-service POS terminal 10 after starting a checkout process at the self-service POS terminal 10 and before the completion of the checkout process, the monitoring device 50 of the present embodiment determines whether an article is left in the space SP for bagging on the self-service POS terminal 10, on the stand 12 for the shopping basket SB, or on the upper surface of the automatic change machine 13. Then, when no article is left, the monitoring device 50 outputs a notification signal indicating the detection of a departure without payment to the attendant terminal 20 or the like. Also, when an article is left but the article is an ineligible article, such as flatware or a receipt, that is not eligible to serve as counter-evidence for departure without payment, the monitoring device 50 outputs a notification signal indicating the detection of the departure without payment. On the other hand, when an article different from any of ineligible articles is left on the self-service POS terminal 10, the monitoring device 50 does not output the notification signal indicating the detection of the departure without payment. In other words, the monitoring device 50 is configured to determine whether the purchaser SH and an article not initially present in the imaging area ARa are detected in the imaging area ARa based on images acquired from the camera 60 (or imaging device), determine that a departure without payment by the purchaser SH has been detected when the purchaser SH previously detected in the imaging area ARa ceases to be detected during a checkout process started by the purchaser SH at the POS terminal 10 and the article is not detected in the imaging area ARa, and transmit a notification signal indicating the detection of the departure without payment to the attendant terminal 20 (or management terminal).

For example, the purchaser SH may temporarily leave the self-service POS terminal 10 during the checkout process to pick up a plastic bag or to pick up a forgotten item on the sales floor. In such a case, the shopping basket SB is generally left on the stand 12. Also, items before registration are left on the self-service POS terminal 10. Furthermore, a reusable bag, a plastic bag, or the like is left in the space SP. As described above, when an article related to the purchaser SH is placed on the self-service POS terminal 10, the monitoring device 50 does not output the notification signal indicating the detection of a departure without payment.

On the other hand, when the purchaser SH is going to leave the checkout zone RE without paying for items, no article related to the purchaser SH is left on the self-service POS terminal 10. Even if an article is left on the self-service POS terminal 10, the article is an unnecessary article, such as a piece of flatware, for the purchaser SH. In this case, the monitoring device 50 outputs a notification signal indicating the detection of a departure without payment.

Thus, a fraudulent activity involving departure without payment is notified only when the purchaser SH tries to leave the checkout zone RE without paying. Even when the purchaser SH goes to pick up a plastic bag or goes to pick up a forgotten item on the sales floor in the middle of a checkout process, such an activity is not notified as a fraudulent activity. Therefore, according to the monitoring device 50 of the present embodiment, it is possible to reduce the risk of false positive reports. Accordingly, it is possible to provide the monitoring device 50 capable of efficiently and effectively preventing or suppressing fraudulent activities involving departure without payment.

In addition, the monitoring device 50 stops the monitoring operation while the self-service POS terminal 10 is in the store-clerk-calling state. Therefore, even if the purchaser SH temporarily leaves the self-service POS terminal 10 to call a store clerk, the activity is not reported as a departure without payment. In other words, the monitoring device 50 is configured to stop monitoring the purchaser SH upon receipt of a state signal indicating the store-clerk-calling state in which a store clerk is being called.

When the purchaser SH temporarily leaves the self-service POS terminal 10, the monitoring device 50 sets the self-service POS terminal 10 to the operation disabled state. The operation disabled state continues until the purchaser SH returns to the self-service POS terminal 10. Therefore, even if another purchaser mistakenly assumes that the self-service POS terminal 10 is vacant and stands in front of the self-service POS terminal 10, the operation disabled state of the self-service POS terminal 10 is not cleared, and the operation of the self-service POS terminal 10 by another purchaser is prevented.

The monitoring device 50 stores, as an initial image, an image of the imaging area Ara including the self-service POS terminal 10 that is captured by the camera 60 from above while the purchaser SH is not present in the person detection area ARb. The monitoring device 50 compares a current image captured by the camera 60 with the initial image. When a person is detected in the person detection area ARb in the current image, it is determined that the purchaser SH is present in front of the self-service POS terminal 10. Thereafter, when no difference is detected in the person detection area ARb between another current image and the initial image, it is determined that the purchaser SH has left the self-service POS terminal 10. In this way, the monitoring device 50 can determine that the purchaser SH is present in front of the self-service POS terminal 10 or that the purchaser SH is away from the self-service POS terminal 10 by comparing images. Compared with a case in which images are analyzed using AI, this configuration makes it possible to reduce the processing load and improve the processing efficiency of the processor 51.

The monitoring device 50 may be used not only for the self-service POS terminal 10 described in the present embodiment but also for other types of self-service POS terminals. For example, instead of the stand 12, a self-service POS terminal may have a space for placing a shopping cart. Also, the automatic change machine 13 may be housed in the terminal housing 11, and the space SP for bagging is provided on one side of the terminal housing 11. Also, the monitoring device 50 of the present embodiment may be used for a dedicated payment machine of a checkout system in which a purchaser registers items by themselves using an information terminal, such as a tablet terminal or a smartphone, and also performs payment by themselves using the payment machine.

### Other Embodiments

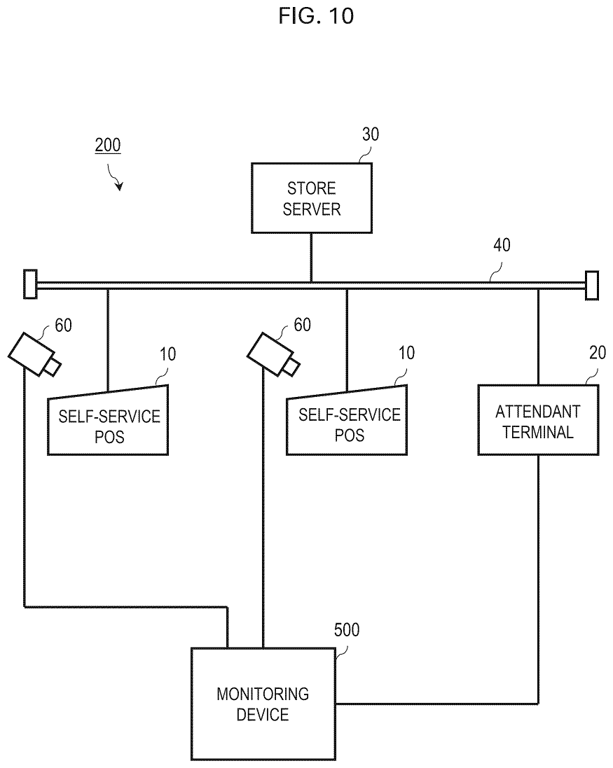

An embodiment of this disclosure is described above. However, this disclosure is not limited to the above-described embodiment. In the above embodiment, one monitoring device 50 is provided for each self-service POS terminal 10. As another embodiment, as in a checkout system 200 shown in FIG. 10, one monitoring device 500 may be provided for a plurality of self-service POS terminals 10, and the monitoring device 500 may centrally monitor purchasers at the self-service POS terminals 10. In this case, the monitoring device 500 acquires a captured image from each of cameras 60 provided for the respective self-service POS terminals 10. The monitoring device 500 also acquires information indicating the state of each self-service POS terminal 10 via the attendant terminal 20. The monitoring device 500 detects a fraudulent activity involving departure without payment for each self-service POS terminal 10 based on the state of the self-service POS terminal 10 and captured images acquired from the camera 60.

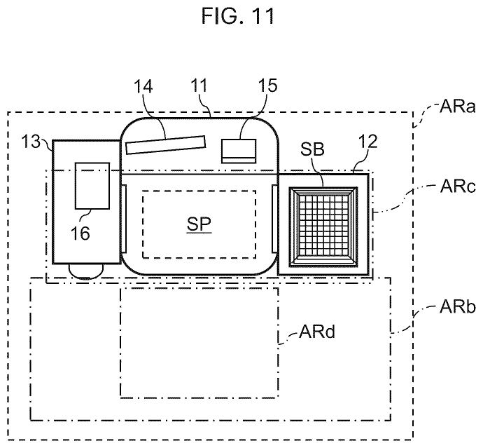

In the above embodiment, an area in front of the terminal housing 11, the stand 12, and the automatic change machine 13 of the self-service POS terminal 10 is set as the person detection area ARb. In another embodiment, as shown in FIG. 11, an area in front of the terminal housing 11 and inside the person detection area ARb is set as a purchaser operation area ARd. Then, when the purchaser SH previously detected in the purchaser operation area ARd ceases to be detected during a checkout process and no article is detected by the article detection unit 514, the monitoring device 50 performs control so that the detection of a departure without payment is notified. With this configuration, even if there are a plurality of persons, such as family members, in front of the self-service POS terminal 10, only one of them enters the person detection area ARb of the self-service POS terminal 10. This makes it possible to reliably detect a fraudulent activity involving departure without payment at the self-service POS terminal 10.

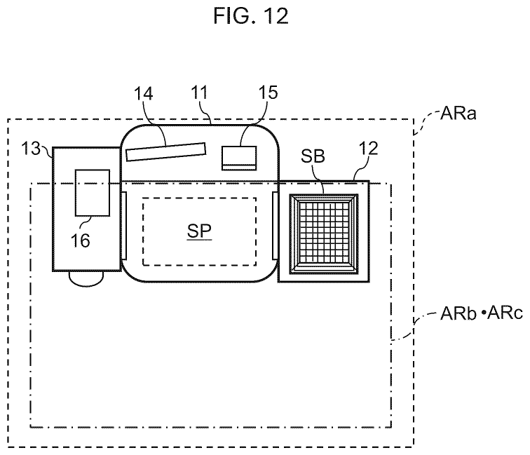

In the above embodiment, the person detection area ARb and the article detection area ARc are described as different areas. As another embodiment, as shown in FIG. 12, the person detection area ARb and the article detection area ARc may be the same area. That is, the monitoring device 50 may determine whether a person is present and whether an article is present by using the same area. Furthermore, the monitoring device 50 may determine whether a person is present and whether an article is present by using the imaging area ARa.

In the above embodiment, the article detection unit 514 uses not only the space SP for bagging on the self-service POS terminal 10 but also spaces on the stand 12 and the automatic change machine 13 as the article detection area ARc. In another embodiment, the article detection unit 514 sets only the space SP for bagging as the article detection area ARc. With this configuration, the monitoring device 50 can detect, for example, a fraudulent activity in which the purchaser SH leaves the self-service POS terminal 10 without paying for items while leaving an empty shopping basket SB on the stand 12.

In the above embodiment, the purchaser detection unit 513 detects the purchaser SH based on the result of comparing images by the first comparison unit 5121. As another embodiment, a human sensor or a weight sensor may be provided in front of the terminal housing 11, and the monitoring device 50 may detect the purchaser SH based on a detection signal from the sensor.

While certain embodiments have been described, these embodiments have been presented by way of example only, and are not intended to limit the scope of the disclosure. Indeed, the novel embodiments described herein may be embodied in a variety of other forms; furthermore, various omissions, substitutions and changes in the form of the embodiments described herein may be made without departing from the spirit of the disclosure. The accompanying claims and their equivalents are intended to cover such forms or modifications as would fall within the scope and spirit of the disclosure.

What is claimed is:

1. A system comprising:
a point of sale (POS) terminal;
a monitoring device connected to the POS terminal;
a management terminal that is connected via a network to the POS terminal and the monitoring device and configured to manage the POS terminal; and
an imaging device that is disposed above the POS terminal, connected to the monitoring device, and configured to capture images of an imaging area including the POS terminal, wherein
the monitoring device is configured to
determine whether a purchaser and an article not initially present in the imaging area are detected in the imaging area based on the images acquired from the imaging device,
determine that a departure without payment by the purchaser has been detected when the purchaser previously detected in the imaging area ceases to be detected during a checkout process started by the purchaser at the POS terminal and the article is not detected in the imaging area, the checkout process including registration of items to be purchased by the purchaser,
transmit a notification signal indicating the detection of the departure without payment to the management terminal,
output an operation disabling signal to the POS terminal to disable operation of the POS terminal when the purchaser previously detected in the imaging area ceases to be detected during the checkout process and the article is detected in the imaging area, and
stop outputting the operation disabling signal when the purchaser is detected again in the imaging area during the checkout process.

2. The system according to claim 1, wherein
the monitoring device is configured to
store, in a memory, an initial image of the imaging area captured by the imaging device while the purchaser is not present in the imaging area,
acquire a first current image captured by the imaging device, and
determine whether the purchaser is detected in the imaging area by comparing the first current image with the initial image.

3. The system according to claim 2, wherein
the monitoring device is configured to
determine whether the registration of the items has been started by the purchaser at the POS terminal after the purchaser is detected,
acquire a second current image captured by the imaging device when the registration of the items has been started,
determine whether the purchaser is detected in the imaging area in the second current image by comparing the second current image with the initial image,
determine whether the article is detected in the imaging area in the second current image by comparing the second current image with the initial image when the purchaser is not detected in the imaging area in the second current image, and
determine that the departure without payment by the purchaser has been detected when the article is not detected in the imaging area in the second current image.

4. The system according to claim 3, wherein
the POS terminal is configured to output a state signal indicating a current state of the POS terminal; and
the monitoring device is configured to determine that the registration of the items has been started upon receipt of the state signal indicating that the registration of the items is in progress.

5. The system according to claim 1, wherein
the monitoring device is configured to
store, in a memory, a person image of the purchaser that is captured by the imaging device immediately after the registration of the items is started by the purchaser at the POS terminal,
acquire a third current image captured by the imaging device after the operation disabling signal is output,
when a person is detected in the third current image, compare the third current image with the person image to determine whether the person in the third current image is the same as the purchaser in the person image, and
stop outputting the operation disabling signal when the person in the third current image is the same as the purchaser in the person image.

6. The system according to claim 1, wherein
when the purchaser previously detected in the imaging area ceases to be detected during the checkout process and the article is detected in the imaging area, the monitoring device is configured to
determine whether the article is an ineligible article that is not eligible to serve as counter-evidence for the departure without payment,
transmit the notification signal to the management terminal when the article is the ineligible article, and
output an operation disabling signal to the POS terminal to disable operation of the POS terminal when the article is not the ineligible article.

7. The system according to claim 6, wherein
when the purchaser previously detected in the imaging area ceases to be detected during the checkout process and either the article is not detected in the imaging area or the detected article is the ineligible article, the monitoring device is configured to
start a timer, and
transmit the notification signal when a time measured by the timer exceeds an allowable time.

8. The system according to claim 1, wherein
the POS terminal is configured to output a state signal indicating a current state of the POS terminal; and
the monitoring device is configured to stop monitoring the purchaser upon receipt of the state signal indicating a store-clerk-calling state in which a store clerk is being called.

9. A method performed by a system including a point of sale (POS) terminal, a monitoring device, a management terminal for monitoring the POS terminal, and an imaging device, the method comprising:
acquiring, by the monitoring device, images of an imaging area including the POS terminal captured by the imaging device;
determining, by the monitoring device, whether a purchaser and an article not initially present in the imaging area are detected in the imaging area based on the images acquired from the imaging device;
determining, by the monitoring device, that a departure without payment by the purchaser has been detected when the purchaser previously detected in the imaging area ceases to be detected during a checkout process started by the purchaser at the POS terminal and the article is not detected in the imaging area, the checkout process including registration of items to be purchased by the purchaser;
transmitting, by the monitoring device, a notification signal indicating the detection of the departure without payment to the management terminal; and
outputting, by the monitoring device, an operation disabling signal to the POS terminal to disable operation of the POS terminal when the purchaser previously detected in the imaging area ceases to be detected during the checkout process and the article is detected in the imaging area, wherein
the operation disabling signal is stopped when the purchaser is detected again in the imaging area during the checkout process.

10. The method according to claim 9, further comprising:
storing, in a memory and by the monitoring device, an initial image of the imaging area captured by the imaging device while the purchaser is not present in the imaging area; and
acquiring, by the monitoring device, a first current image captured by the imaging device, wherein
the monitoring device determines whether the purchaser is detected in the imaging area by comparing the first current image with the initial image.

11. The method according to claim 10, further comprising:
determining, by the monitoring device, whether the registration of the items has been started by the purchaser at the POS terminal after the purchaser is detected;
acquiring, by the monitoring device, a second current image captured by the imaging device when the registration of the items has been started;
determining, by the monitoring device, whether the purchaser is detected in the imaging area in the second current image by comparing the second current image with the initial image; and
determining, by the monitoring device, whether the article is detected in the imaging area in the second current image by comparing the second current image with the initial image when the purchaser is not detected in the imaging area in the second current image, wherein
the monitoring device determines that the departure without payment by the purchaser has been detected when the article is not detected in the imaging area in the second current image.

12. The method according to claim 11, further comprising:
outputting, by the POS terminal, a state signal indicating a current state of the POS terminal, wherein
the monitoring device determines that the registration of the items has been started upon receipt of the state signal indicating that the registration of the items is in progress.

13. The method according to claim 9, further comprising:
storing, in a memory and by the monitoring device, a person image of the purchaser that is captured by the imaging device immediately after the registration of the items is started by the purchaser at the POS terminal;
acquiring, by the monitoring device, a third current image captured by the imaging device after the operation disabling signal is output; and
when a person is detected in the third current image, comparing, by the monitoring device, the third current image with the person image to determine whether the person in the third current image is the same as the purchaser in the person image, wherein
the monitoring device stops outputting the operation disabling signal when the person in the third current image is the same as the purchaser in the person image.

14. The method according to claim 9, further comprising:
when the purchaser previously detected in the imaging area ceases to be detected during the checkout process and the article is detected in the imaging area,
determining, by the monitoring device, whether the article is an ineligible article that is not eligible to serve as counter-evidence for the departure without payment,
transmitting, by the monitoring device, the notification signal to the management terminal when the article is the ineligible article, and
outputting, by the monitoring device, an operation disabling signal to the POS terminal to disable operation of the POS terminal when the article is not the ineligible article.

15. The method according to claim 14, further comprising:
starting, by the monitoring device, a timer when the purchaser previously detected in the imaging area ceases to be detected during the checkout process and either the article is not detected in the imaging area or the detected article is the ineligible article, wherein
the monitoring device transmits the notification signal when a time measured by the timer exceeds an allowable time.

16. A non-transitory computer readable storage medium storing a program for causing a processor of a monitoring device to perform a process including:
acquiring images of an imaging area including a point of sale (POS) terminal captured by an imaging device;
determining whether a purchaser and an article not initially present in the imaging area are detected in the imaging area based on the images acquired from the imaging device;
determining that a departure without payment by the purchaser has been detected when the purchaser previously detected in the imaging area ceases to be detected during a checkout process started by the purchaser at the POS terminal and the article is not detected in the imaging area, the checkout process including registration of items to be purchased by the purchaser;
transmitting a notification signal indicating the detection of the departure without payment to a management terminal that controls the POS terminal; and
outputting an operation disabling signal to the POS terminal to disable operation of the POS terminal when the purchaser previously detected in the imaging area ceases to be detected during the checkout process and the article is detected in the imaging area, wherein
the operation disabling signal is stopped when the purchaser is detected again in the imaging area during the checkout process.
